(19) United States
(12) Patent Application Publication
(10) Pub. No.: US 2006/0029265 A1
(43) Pub. Date: Feb. 9, 2006

(54) Face detection method based on skin color and pattern match

(75) Inventors: Jungbae Kim, Yongin-si (KR); Youngsu Moon, Seoul (KR); Jiyeun Kim, Seoul (KR); Seokcheol Kee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/195,611

(22) Filed: Aug. 3, 2005

(30) Foreign Application Priority Data
Aug. 4, 2004 (KR) 10-2004-0061417

(51) Int. Cl. G06K 9/00

(52) U.S. Cl. 382/118

(57) ABSTRACT

A face detection method based on a skin color and a pattern match. A face detection method includes: detecting skin color pixels using color information of an image; calculating a proportion of the skin color pixels occupying each predetermined sub-window of the image; selecting ones of the predetermined sub-windows as face candidates when the proportions of the skin color pixels in the ones of the sub-windows are at least equal to a threshold value; and determining whether any of the face candidates is a face and storing a location of the face.

### CROSS-REFERENCE TO RELATED APPLICATION

This application claims the benefit of Korean Patent Application No. 2004-0061417, filed on Aug. 4, 2004, in the Korean Intellectual Property Office, the disclosure of which is incorporated herein by reference.

### BACKGROUND OF THE INVENTION

1. Field of the Invention

The present invention relates to a face detection method based on a skin color and a pattern match and, more particularly, to a face detection method where face candidates are selected using a skin color in an image and it is determined whether each of the selected face candidates is a face or a non-face using a pattern match.

2. Description of Related Art

A face detection technique based on a pattern match produces the best performance among the well-known face detection techniques up to now. However, since the face detection technique based on a pattern match conducts a pattern match process on an overall region of an input image, the pattern match process may be also conducted on non-face regions. Accordingly, there is a problem in that unnecessary time is consumed unnecessarily for pattern matching, and a false alarm or false acceptance, which indicates that a non-face region is mistakenly determined to be a face, and a false rejection, which indicates that a face region is mistakenly determined to be a non-face region, are apt to occur. Further, a detection failure is apt to occur when a face pose which is not learned.

As another example of the face detection technique, there is a skin color based face detection technique. In this case, however, there is also a problem in that a skin color in an image sensitively responds depending on illumination, and the non-face regions, such as a neck or arm portion, are detected together with the face.

### BRIEF SUMMARY

An aspect of the present invention provides a method of detecting a face location in an image by selecting face candidates using an integral image of a skin color in the image and determining whether each of the selected face candidates is a face or a non-face by applying an Adaboost algorithm, one of pattern match methods, to the selected face candidates.

According to an aspect of the present invention, there is provided a face detection method including: detecting skin color pixels using color information of an image; calculating a proportion of the skin color pixels occupying each predetermined sub-window of the image; selecting ones of the predetermined sub-windows as face candidates when the proportions of the skin color pixels in the ones of the sub-windows are at least equal to a threshold value; and determining whether any of the face candidates is a face and storing a location of the face.

According to another aspect of the present invention, there is provided a face detection method in a current frame of a moving image, comprising: determining whether there is motion in the current frame when a face is detected in a previous frame; detecting a face in a tracking window in the current frame determined to be centered around a location of the face detected in the previous frame when no motion is detected; and storing a location of the detected face in the current frame.

According to other aspects of the present invention, there are provided computer-readable storage media encoded with processing instructions for causing a processor to perform the aforementioned face detection methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart showing a face detection method in a still image according to an embodiment of the present invention;

FIG. 2A shows an input image;

FIG. 2B shows an image where a skin color is detected from the image of FIG. 2A;

FIG. 3 shows an example of obtaining an integral sum using an integral image;

FIG. 4 shows portions determined to be a face candidate in the image of FIG. 2A;

FIG. 5, parts (a)-(f), shows an example of a feature used in an Adaboost algorithm, which is one example a of pattern match method;

FIG. 6A shows an example of a feature, which is used in pattern matching, based on a fact that two eyes and a portion between two eyes are different from each other in luminance;

FIG. 6B shows an example of a feature, which is used in pattern matching, based on a fact that an eye portion and a portion below the eye are different from each other in luminance;

FIG. 7A shows an example of a face candidate group selected in FIG. 4;

FIG. 7B shows locations of faces detected by applying an Adaboost algorithm to the face candidate group of FIG. 7A;

FIG. 8 is a flowchart showing a face detection method in a moving image;

FIG. 9A shows images where there has been a motion in consecutive 10 frames;

FIG. 9B shows temporal edges detected by applying a Laplacian-of-Gaussian filter to the frames of FIG. 9A;

FIG. 10 shows an example of a tracking window;

FIG. 11A shows a lateral face; and

FIG. 11B shows a skin color image obtained from the image of FIG. 11A.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

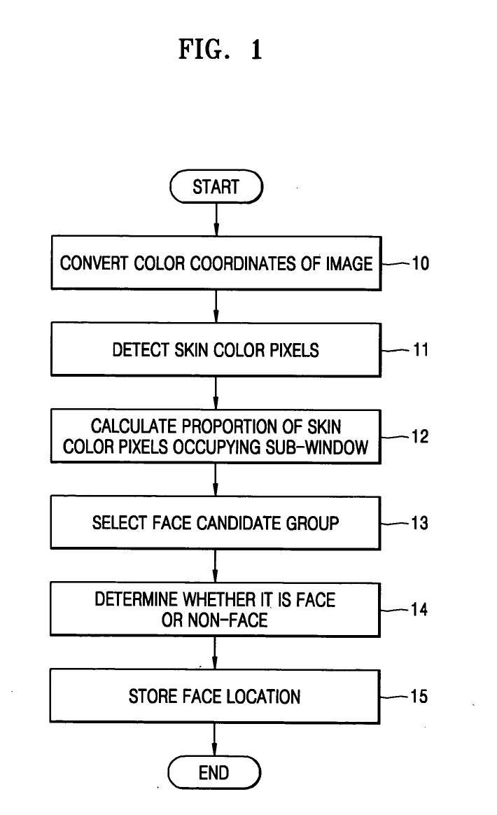

FIG. 1 is a flowchart showing a face detection method in a still image according to an embodiment of the present invention. First, RGB color coordinates of an input image are converted to YCbCr (luma and chroma) color coordinates (operation 10). The color coordinates are converted according to the following set of equations:
Y=0.299R+0.587G+0.114B
Cb=−0.169R−0.331G+0.5B+0.5
Cr=0.5R−0.419G−0.081B+0.5 [Equation Set 1]

Pixels satisfying the following set of conditions with respect to the converted YCbCr values are detected as skin color pixels (operation 11):
If (Y<Y⁻ or Y>Y⁺ or Cb<Cb⁻or Cb>Cb⁺ or Cr<Cr⁻ or Cr>Cr⁺)

then non-skin color.
If (Y>Y* and (Cr−Cb)>C*) [Equation Set 2]

then non-skin color.

Otherwise, skin-color.

where Y⁻, Y⁺, Y*, Cb⁻, Cb⁺, Cr⁻, Cr⁺, C* are threshold values and may be initially fixed. The threshold values may be set in a wide range so that a skin color in an image is insensitive to a variation in luminance.

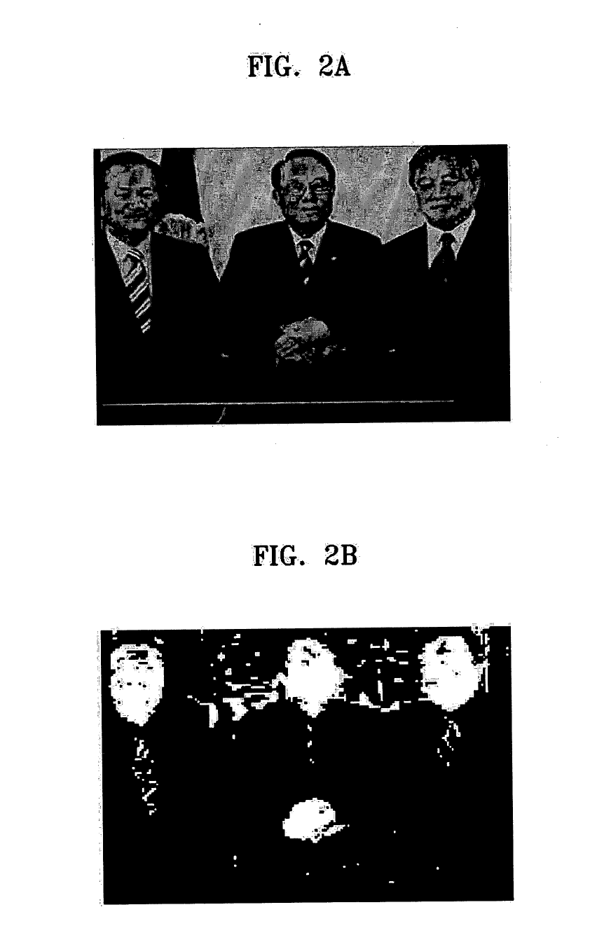

FIG. 2 shows a skin color image detected from an input image. FIG. 2A shows an input image, and FIG. 2B shows an image where a skin color is detected. Referring to FIG. 2B, pixels corresponding to faces and hands of three persons are detected as having a skin color.

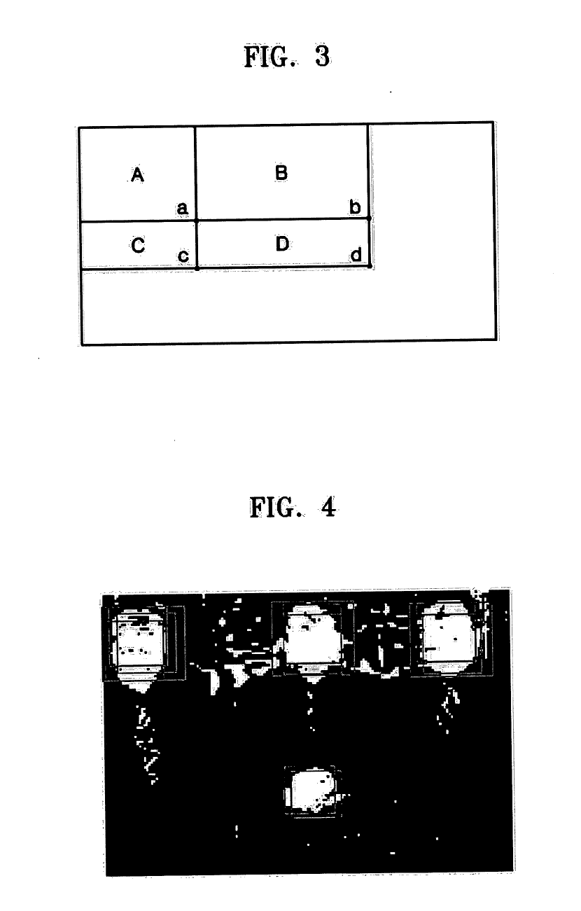

Next, a proportion P of skin color pixels occupying a predetermined sub-window is calculated using the integral image scheme in the skin color image (operation 12). The integral image indicates a sum of the numbers of pixels located at an upper and left side of a certain pixel in an image. For instance, an integral image ii(a) for an ‘a’ pixel shown in FIG. 3 is the sum of the numbers of the pixels located at the upper and left side of the ‘a’ pixel. As another example, the integral sum in D region is ii(d)+ii(a)−ii(b)−ii(c).

The sub-window of a minimum size of, for example, 20×20 pixels is shifted to scan an overall region of an image, starting from, for examples, the top-left side of the image. After the scanning is completed, the sub-window of an increased size of, for example, 1.2 times of the minimum size is shifted again to scan an overall region of the image. Finally, the sub-window may increase up to the size of the overall region of the image. If a proportion of skin color pixels occupying the sub-window is greater than or equal to a predetermined threshold value, the sub-window is selected as a face candidate. If the proportion is less than the threshold value, the sub-window is excluded as a face candidate (operation 13). FIG. 4 shows portions determined to be face candidates. Sub-windows of different sizes overlap in the portions determined to be face candidates.

A pattern match process is conducted on each sub-window determined to be a face candidate, whereby it is determined whether the sub-window includes a face (operation 14). As a pattern match method, an Adaboost algorithm is employed, which uses a luminance component Y of the image output in operation 10. Lastly, the location of a detected face is stored in operation 15.

A more detailed description of face pattern matching according to the Adaboost algorithm is as follows. The Adaboost algorithm applies a number of so-called “weak” classifiers to regions of interest, such as eye-, nose-, or mouth-region, within a face candidate sub-window, and determines whether it is a face depending on a so-called “strong” classifier made up of a weighted sum of classification results of the weak classifiers. A selection of the classification results of the weak classifiers and weights is achieved through a learning process using the following Adaboost algorithm:

$$H ( x ) = sign [ {\sum }_{m = 1}^{M} {c}_{m} \cdot {f}_{m} ( x ) ] \qquad [ Equation 3 ]$$

where H(x) denotes a strong classifier, M denotes the number of weak classifiers, cₘ denotes a weight determined through a learning process, and fₘ(x) denotes an output value of a weak classifier through a learning process. fₘ(x) consists of a classification feature expressed by the following equation and a threshold value for a region of interest:
fₘ(x)∈{−1,1} [Equation 4]
where 1 denotes a face, and −1 denotes a non-face.

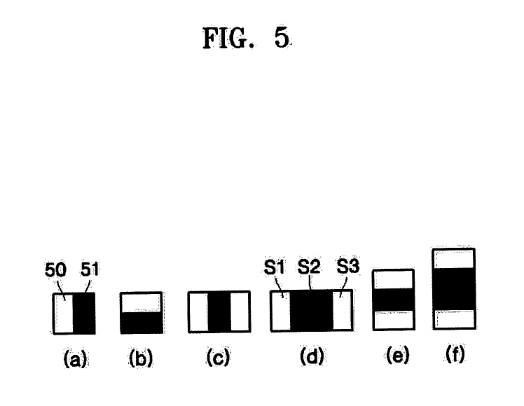

Such a classification feature can be obtained from the sum of a number of rectangles like FIG. 5, parts (a) through (f). It is determined whether a region of interest is included in a face by subtracting a luminance sum of a black color portion 51 from a luminance sum of reference numeral 50, and comparing the subtraction result with a predetermined threshold value. Sizes, locations, or shapes of reference numerals 50 and 51 can be obtained through a learning process.

For instance, if the luminance sums for each portion of part (d) of FIG. 5 are s1, s2, and s3, respectively, an overall feature value is equal to s1+s3−s2. If s is greater than the threshold value, it is classified as a face. If s is no greater than the threshold value, it is classified as a non-face.

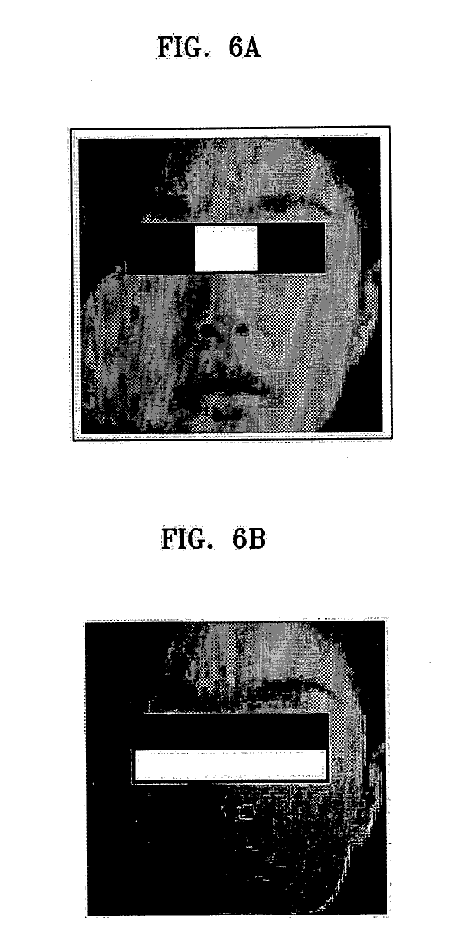

Cases where the classification features are applied to regions of interest are shown in FIG. 6. Referring to FIG. 6, different classification features can be applied to the same interested region in a face candidate. FIG. 6A and 6B are cases where the Adaboost algorithm having different classification features is applied to an eye portion.

FIG. 6A shows a classification feature based on a fact that two eyes and a portion between two eyes are different from each other in luminance. FIG. 6B shows a classification feature based on a fact that an eye portion and a portion below the eye are different from each other in luminance.

It is determined whether an image corresponds to a face or a non-face by considering all classification results depending on several to hundreds of classification features, including the classification results of FIGS. 6A and 6B.

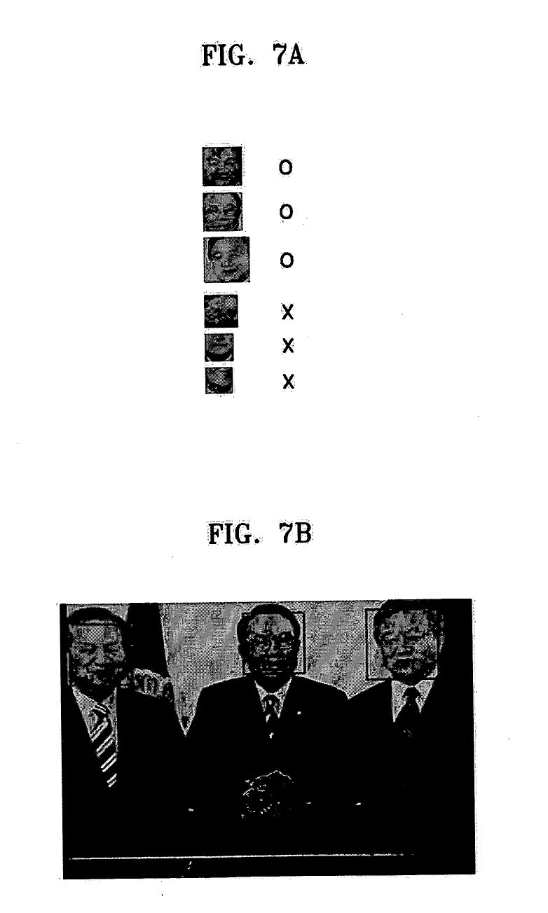

FIG. 7A shows an example of a face candidate group selected in FIG. 4. FIG. 7B shows locations of faces detected by applying the Adaboost algorithm to the face candidate group of FIG. 7A. As can be seen from FIGS. 7A and 7B, sub-windows including hands or only a portion of a face among the face candidate group shown in FIG. 7A are classified as a non-face and removed.

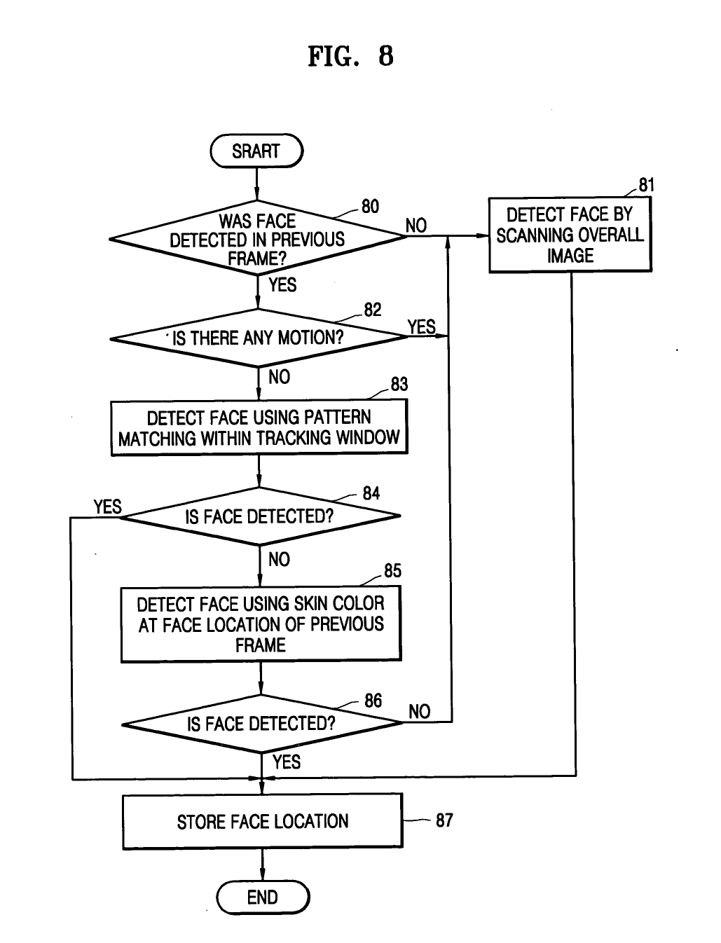

FIG. 8 is a flowchart showing a face detection method in a moving image.

In the method of detecting of a face in a moving image, it is determined whether a face was detected in a previous frame (operation 80). If a face was not detected in the previous frame, a face is detected using a skin color and a pattern match by scanning an overall image of a current frame according to the face detection method shown in FIG. 1 (operation 81).

If a face was detected in the previous frame, it is determined whether there is any motion (operation 82). If there is any motion, face location information of the previous frame cannot be used since there may occur a case where a scene completely changes or a new person appears, etc. It is determined whether there is any motion by applying the following Laplacian-of-Gaussian filter to consecutive 10 frames and detecting temporal edges:

$${∇}^{2} G ( t ) = \{ \frac{{t}^{2} - {σ}^{2}}{{σ}^{4}} \} exp \{ - \frac{{t}^{2}}{2 {σ}^{2}} \} \qquad [ Equation 5 ]$$

where σ denotes a variance.

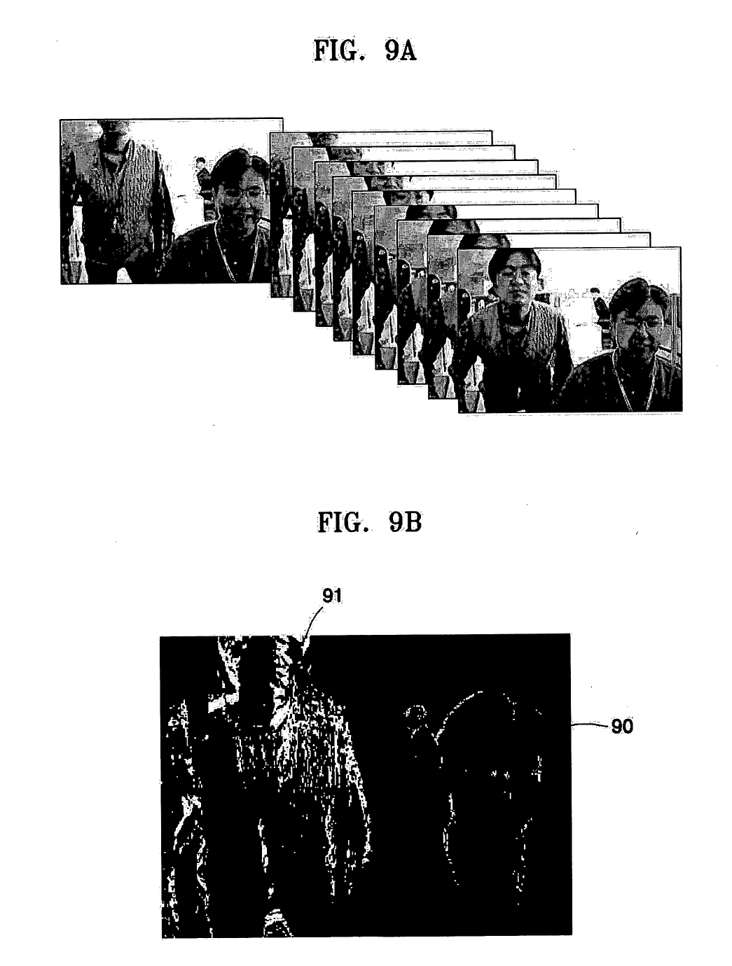

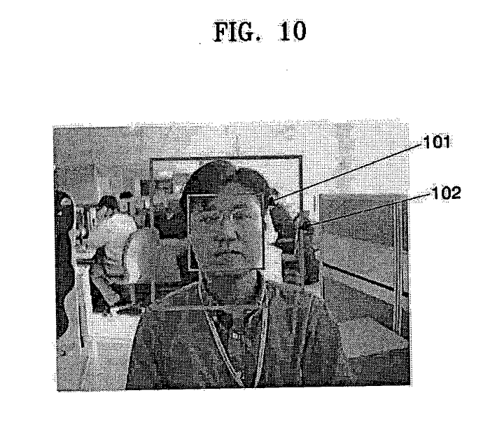

If the intensity of the detected temporal edges is greater than or equal to a threshold value, it is determined that there has been any motion. FIG. 9A shows images where there has been a motion in consecutive 10 frames. FIG. 9B shows temporal edges detected by applying the Laplacian-of-Gaussian filter to the frames of FIG. 9A. Referring to FIGS. 9A and 9B, a fixed object 90 shows weak temporal edge intensities, while a moving object 91 shows strong temporal edge intensities.

If any motion is detected, the process proceeds to operation 81 where a face is detected using the skin color and the pattern match by scanning the overall image of a current frame.

If no motion is detected, a face can be regarded as being at a location corresponding to the previous frame. In this case, a face is detected within a tracking window of the current frame (operation 83). The tracking window refers to a window having about four times of the size of the face detected in the previous frame at the same location as one of the faces detected in the previous frame. FIG. 10 shows an example of the tracking window. Reference numeral 101 denotes a face location detected in a previous frame, and reference numeral 102 denotes a tracking window. Face detection is conducted by applying the Adaboost algorithm to the tracking window.

If a face is detected in the tracking window, the face location is stored (operation 87).

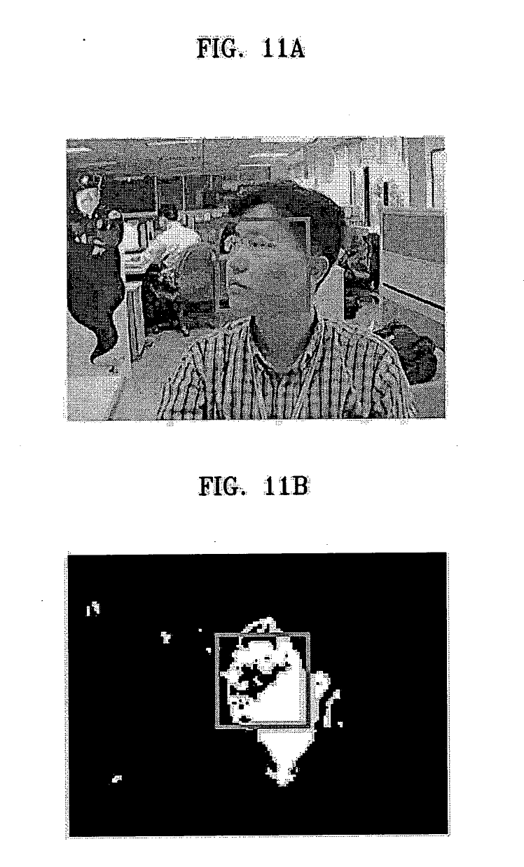

If a face is not detected within the tracking window, a face is detected using a skin color at the same location as one detected in the previous frame (operation 85). If no face is detected within the tracking window, there may be any changes in a face direction or pose rather than the face location, compared with the previous frame. For instance, if a frontal face shown in FIG. 10 is changed to a lateral face shown in FIG. 11A, it is difficult to detect the face by applying the face detection method based on the pattern match, such as the Adaboost algorithm. Accordingly, in this case, a face detection method based on a skin color can be employed for face detection. That is, a face is detected by obtaining a skin color image as shown in FIG. 11B and calculating a proportion of the skin color occupying a window using the integral image scheme.

If a face is detected, the face location is stored (operation 87). If not, the process proceeds to operation 81 where a face detection is conducted using the skin color and the pattern match by scanning the overall image.

The above-described embodiments of the present invention can be implemented as a computer-readable code in a computer-readable storage medium. Examples of the computer-readable storage medium include all kinds of recording devices for storing data to be read by a computer system, such as ROM, RAM, CD-ROM, magnetic tape, floppy disk, and optical data storage device. A medium implemented in a form of a carrier wave (e.g., a transmission over Internet) is another example of the computer-readable storage medium. Further, the computer-readable storage medium can be distributed in a computer system connected over a network, and the computer-readable code is recorded and implemented in a distributed manner.

According to the above-described embodiments of the present invention, it is possible to rapidly detect a face compared with a conventional pattern-based face detection method by selecting a face candidate group using a skin color, and determining whether the face candidates are a face or a non-face by adapting the Adaboost algorithm to the face candidate group.

For instance, when the pattern-based face detection method is applied to a still image with 320×240 pixels, it takes 32 ms for a PENTIUM® IV 2.53 GHz processor (PENTIUM is a Trademark of Intel Corporation) to detect a face, whereas it takes 16 ms according to the present invention.

In addition, when the pattern-based face detection method is applied to a moving image with 320×240 pixels, it takes 32 ms for the PENTIUM® IV 2.53 GHz processor (PENTIUM is a Trademark of Intel Corporation) to detect a face, whereas it takes 10 ms according to the present invention.

Further, since face candidates are selected using a skin color in the present invention, it is possible to remove a false alarm in advance.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A face detection method comprising:
detecting skin color pixels using color information of an image;
calculating a proportion of the skin color pixels occupying each predetermined sub-window of the image;
selecting ones of the predetermined sub-windows as face candidates when the proportions of the skin color pixels in the ones of the sub-windows are at least equal to a threshold value; and
determining whether any of the face candidates is a face and storing a location of the face.

2. The method of claim 1, wherein the color information of the image is obtained by converting RGB color coordinates of the image to YCrCb color coordinates.

3. The method of claim 2, wherein the skin color pixels are detected when the skin color pixels satisfies the following conditions:
If (Y<Y⁻ or Y>Y⁺ or Cb<Cb⁻or Cb>Cb⁺ or Cr<Cr⁻ or Cr>Cr⁺)
then non-skin color.
If (Y>Y* and (Cr−Cb)>C*)
then non-skin color.
Otherwise, skin-color.
Y⁻, Y⁺, Y*, Cb⁻, Cb⁺, Cr⁻, Cr⁺, C* denoting constants.

4. The method of claim 1, wherein the sub-window of a minimum size is shifted to scan an overall region of the image.

5. The method of claim 4, wherein the sub-window is shifted to scan the overall region of the image while increasing by a predetermined rate from the minimum size to the size corresponding to the overall region of the image.

6. The method of claim 1, wherein the skin color pixels are calculated using an integral image.

7. The method of claim 1, wherein each face candidate is determined to be a face when a plurality of classifiers is applied to a region corresponding to the face candidate, a weighted sum of classification results output from the classifiers is obtained, and the weighted sum is greater than a second threshold value.

8. The method of claim 7, wherein each of the classifiers determines a region of interest as a face region when a predetermined classification feature is applied to the region of interest among the face candidates, luminance values of the region of interest are added or subtracted depending on the applied classification feature, and the added or subtracted result is greater than a third threshold value.

9. A face detection method in a current frame of a moving image, comprising:
determining whether there is motion in the current frame when a face was detected in a previous frame;
detecting a face in a tracking window in the current frame determined to be centered around a location of the face detected in the previous frame when no motion is detected; and
storing the face location of the detected face in the current frame.

10. The method of claim 9, wherein the presence of motion is determined by detecting temporal edges for a predetermined number of consecutive frames and determining that the temporal edges are greater than a threshold value.

11. The method of claim 10, wherein the temporal edges are detected by applying a Laplacian-of-Gaussian filter to the frames.

12. The method of claim 9, wherein the face is detected by scanning the entire current frame when it is determined that there is any motion in the current frame.

13. The method of claim 9, wherein the size of the tracking window is greater than that of the face detected at the location in the current frame corresponding to the location of the face detected in the previous frame.

14. The method of claim 9, further comprising, when no face is detected in the tracking window,
detecting skin color pixels at a location in the current frame corresponding to the location of the face detected in the previous frame using color information of the current frame;
calculating a proportion of the skin color pixels occupying a predetermined sub-window centered around the location in the current frame; and
determining the sub-window to be a face when the proportion of the skin color pixels is greater than or equal to a predetermined threshold value, and storing a face location.

15. The method of claim 14, wherein the face is detected by scanning an entirety of the current frame when no face is detected at the location in the current frame corresponding to the location of the face detected in the previous frame.

16. The method of claim 1, wherein the determining comprises performing pattern matching using an Adaboost algorithm on each sub-window determined to be a face candidate.

17. The method of claim 9, wherein the determining comprises performing pattern matching using an Adaboost algorithm on each sub-window determined to be a face candidate.

18. A computer-readable storage medium encoded with processing instructions for causing a processor to execute a method of detecting a face, the method comprising:
detecting skin color pixels using color information of an image;
calculating a proportion of the skin color pixels occupying each predetermined sub-window of the image;
selecting ones of the predetermined sub-windows as face candidate when the proportion of the skin color pixels in the ones of the sub-windows are at least equal to a threshold value; and
determining whether any of the face candidate is a face and storing a location of the face.

19. A computer-readable storage medium encoded with processing instructions for causing a processor to execute a face detection method in a current frame among consecutive image frames, comprising:
determining whether there is motion in the current frame when a face was detected in a previous frame;
detecting a face in a tracking window determined to be centered around a location of the face detected in the previous frame when no motion is detected; and
storing a location of the detected face in the current frame.
